(19) United States
(12) Patent Application Publication
(10) Pub. No.: US 2026/0204272 A1
(43) Pub. Date: Jul. 16, 2026

(54) ECHO CANCELLATION METHOD, DEVICE AND COMPUTER-READABLE STORAGE MEDIUM

(71) Applicant: UBTECH ROBOTICS CORP LTD, Shenzhen (CN)

(72) Inventors: ZEHONG ZHENG, Shenzhen (CN); Dongyan Huang, Shenzhen (CN); Xianjie Yang, Shenzhen (CN); Wan Ding, Shenzhen (CN)

(21) Appl. No.: 19/430,391

(22) Filed: Dec. 23, 2025

Related U.S. Application Data
(63) Continuation of application No. PCT/CN2023/141221, filed on Dec. 22, 2023.

(30) Foreign Application Priority Data
Aug. 31, 2023 (CN) 202311129179.6

(51) Int. Cl. G10L 21/0208

(52) U.S. Cl. CPC G10L 21/0208; G10L 2021/02082

(57) ABSTRACT

An echo cancellation method includes: acquiring a reference-aligned signal and a microphone-aligned signal; filtering the reference-aligned signal and the microphone-aligned signal by using a preset adaptive filter to obtain a filter output signal; performing speech compensation processing on the filter output signal according to the reference-aligned signal and the microphone-aligned signal to obtain a compensated speech signal; and performing nonlinear processing on the compensated speech signal to obtain an echo-cancelled speech signal.

### CROSS REFERENCE TO RELATED APPLICATIONS

The present application is a continuation-application of International Application PCT/CN2023/141221, with an international filing date of Dec. 22, 2023, which claims foreign priority to Chinese Patent Application No. 202311129179.6, filed on Aug. 31, 2023, in the China National Intellectual Property Administration, the contents of all of which are hereby incorporated by reference in its entirety.

### TECHNICAL FIELD

The present disclosure generally relates to the technical field of acoustic processing, and in particular, relates to an echo cancellation method, device and computer-readable storage medium.

### BACKGROUND

In a human-machine voice interaction system, a pickup device may be employed to acquire a user's speech, and a playback device may be employed to output a corresponding response. To improve the user experience, these two processes are typically performed simultaneously. However, when the user speaks during the audio playback process, the acquired signal becomes a mixture of the user's speech and the playback sound, which may result in incorrect judgments and responses. Therefore, during the pickup process, it is necessary to perform acoustic echo cancellation (AEC) on the playback sound.

However, when using some conventional echo cancellation methods, a portion of the user's speech may be lost after echo cancellation, making it difficult to accurately recognize the user's speech content and thereby affecting normal interaction with the user.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic block diagram of a device according to one embodiment.

FIG. 2 is an exemplary block diagram of an ACE module according to one embodiment.

FIG. 3 is an exemplary flowchart of an echo cancellation method according to another embodiment.

FIG. 4 shows a schematic diagram of the input and output of an adaptive filter.

FIG. 5 shows a schematic diagram of a speech compensation module according to one embodiment.

FIG. 6 is a block diagram of an echo cancellation device according to one embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

In a human-machine voice interaction system, a pickup device may be employed to acquire a user's speech, and a playback device may be employed to output a corresponding response. To improve the user experience, these two processes are typically performed simultaneously. However, when the user speaks during the audio playback process, the acquired signal becomes a mixture of the user's speech and the playback sound, which may result in incorrect judgments and responses. Therefore, during the pickup process, it is necessary to perform acoustic echo cancellation (AEC) on the playback sound.

However, when using some conventional echo cancellation methods, a portion of the user's speech may be lost after echo cancellation, making it difficult to accurately recognize the user's speech content and thereby affecting normal interaction with the user.

In view of the foregoing, embodiments of the present disclosure provide an echo cancellation method, an apparatus, a computer-readable storage medium, and a device. It should be noted that the entity executing the method of the present disclosure is a device 100, which may include, but is not limited to, a desktop computer, a laptop computer, a handheld computer, an intelligent interactive display, a robot, or other conventional computing devices.

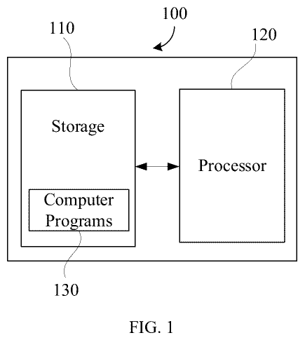

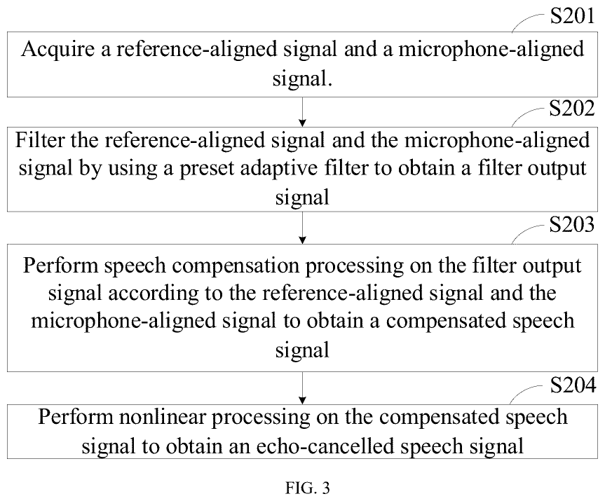

Referring to FIG. 1, in one embodiment, the device 100 may include a storage 110 and a processor 120. The storage 110 and the processor 120 are directly or indirectly electrically connected to one another to enable data transmission or interaction. For example, they can be electrically connected to each another through one or more communication buses or signal lines. The processor 120 performs corresponding operations by executing the executable computer programs 130 stored in the storage 110. When the processor 120 executes the computer programs 130, the steps in the embodiments of an echo cancellation method, such as steps S201 to S204 in FIG. 3 are implemented.

The processor 120 may be an integrated circuit chip with signal processing capability. The processor 120 may be a central processing unit (CPU), a graphics processing unit (GPU), a general-purpose processor, a network processor (NP), a digital signal processor (DSP), an application specific integrated circuit (ASIC), a field-programmable gate array (FPGA), a programmable logic device, a discrete gate, a transistor logic device, or a discrete hardware component. The general-purpose processor may be a microprocessor or any conventional processor or the like. The processor 120 can implement or execute the methods, steps, and logical blocks disclosed in the embodiments of the present disclosure.

The storage 110 may be, but not limited to, a random-access memory (RAM), a read only memory (ROM), a programmable read only memory (PROM), an erasable programmable read-only memory (EPROM), and an electrical erasable programmable read-only memory (EEPROM). The storage 110 may be an internal storage unit of the device 100, such as a hard disk or a memory. The storage 110 may be an external storage device of the device 100, such as a plug-in hard disk, a smart memory card (SMC), and a secure digital (SD) card, or any suitable flash cards. Furthermore, the storage 110 may include both an internal storage unit and an external storage device. The storage 110 is to store computer programs, other programs, and data required by the device 100. The storage 110 can be used to temporarily store data that has been output or is about to be output. Upon receiving an execution instruction, the processor 120 can correspondingly execute the computer program stored on the storage 110.

Exemplarily, the one or more computer programs 130 may be divided into one or more modules/units, and the one or more modules/units are stored in the storage 110 and executable by the processor 120. The one or more modules/units may be a series of computer program instruction segments capable of performing specific functions, and the instruction segments are used to describe the execution process of the one or more computer programs 130 in the device 100.

It should be noted that the block diagram shown in FIG. 1 is only an example of the electronic device. The electronic device may include more or fewer components than what is shown in FIG. 1, or have a different configuration than what is shown in FIG. 1. Each component shown in FIG. 1 may be implemented in hardware, software, or a combination thereof.

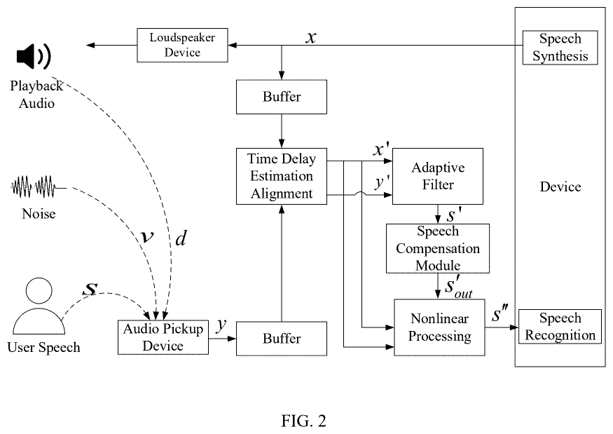

Referring to FIG. 2, the echo cancellation method of the present disclosure may incorporate a preset speech compensation module into the acoustic echo cancellation (AEC) module of an existing WebRTC framework, and the speech compensation module is used to perform speech compensation processing on the filter output signal. In this way, during subsequent speech recognition processing, the user's speech content can be recognized more accurately, thereby ensuring normal interaction between the device 100 and the user.

FIG. 3 is an exemplary flowchart of an echo cancellation method according to one embodiment. This method can be implemented by the device 100 described above. In one embodiment, the method may include steps S201 to S204.

Step S201: Acquire a reference-aligned signal and a microphone-aligned signal.

In the embodiment, after generating the corresponding response content and performing speech synthesis, the synthesized speech may be stored in a preset buffer as a reference input signal for the echo cancellation process. During echo cancellation, the reference input signal x may be obtained from the buffer, and a microphone or other pickup device may be used to capture audio to obtain a microphone input signal y. The microphone input signal may include a user speech component x (i.e., the user's spoken voice), an ambient noise component v, and a playback-sound component output d (also referred to as an echo component) by the loudspeaker device, i.e., y=(s+v)+d. Since the playback-sound component d captured by the pickup device is the attenuated version of the reference input signal x after acoustic propagation, and is affected by factors such as the room structure and the performance of the loudspeaker device, we have: d=x*h+d′, where h represents the room impulse response, * represents convolution, and d′ represents a nonlinear echo component.

It should be understood that the reference input signal and the microphone input signal may not be aligned in the time domain. A certain time delay may exist in the reference input signal relative to the microphone input signal. If the two signals are directly fed into a preset adaptive filter (AF) for filtering under such circumstances, strong residual echo may occur, causing the adaptive filter to fail. Therefore, in one embodiment, time-domain alignment may be performed on the reference input signal x and the microphone input signal y to obtain time-synchronized reference-aligned signal x′ and microphone-aligned signal y′.

Specifically, any common time-domain alignment method in the prior art may be used to perform time-domain alignment between the reference input signal and the microphone input signal. For example, the time delay of the reference input signal relative to the microphone input signal may be estimated by calculating the cross-correlation between the two signals. The two signals may then be aligned in the time domain according to the estimated time delay to obtain the reference-aligned signal and the microphone-aligned signal.

Step S202: Filter the reference-aligned signal and the microphone-aligned signal by using a preset adaptive filter to obtain a filter output signal.

In one embodiment, the preset adaptive filter may perform filtering on the reference-aligned signal x′ and the microphone-aligned signal y′ based on the correlation between the reference input signal x and the microphone input signal y, thereby suppressing the echo component in the microphone input signal and obtaining a filter output signal s′.

Step S203: Perform speech compensation processing on the filter output signal according to the reference-aligned signal and the microphone-aligned signal to obtain a compensated speech signal.

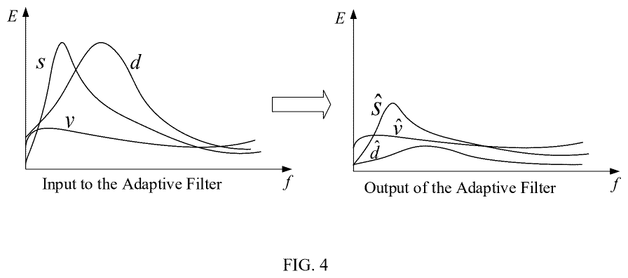

It should be understood that when only the user is speaking (speaking-only stage) or only the device 100 is playing back audio (echo-only stage), the adaptive filter can achieve relatively good processing results. However, when the user speaks while the device 100 is playing back audio (simultaneous speech and playback stage), both the user's speech and the playback sound are present. In this case, the adaptive filter can suppress the echo component d, but it also suppresses a portion of the user's speech s and the ambient noise v. Specifically, as shown in FIG. 4, compared with the input user speech ŝ, ambient noise \hat{v}, and playback sound \hat{d}, the output user speech s, ambient noise v, and playback sound d show that the playback sound d is suppressed, but part of the user speech s and ambient noise v is also lost. This may result in the device 100 being unable to accurately recognize the user's speech content, affecting normal interaction with the user.

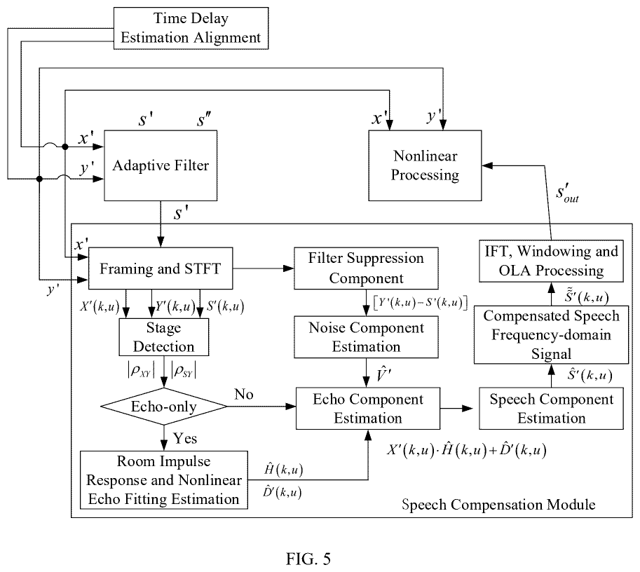

Therefore, in one embodiment, a speech compensation module as shown in FIG. 5 may be used to perform speech compensation processing on the filter output signal, thereby obtaining a compensated speech signal. Specifically, step S203 may include the processes as follows.

Step S2031: Perform frequency-domain transformation on the reference-aligned signal, the microphone-aligned signal, and the filter output signal to obtain a reference-aligned transformed signal, a microphone-aligned transformed signal, and a filter-output transformed signal.

In one embodiment, the reference-aligned signal, the microphone-aligned signal, and the filter output signal may be converted from the time domain to the linear frequency domain through a frequency-domain transformation, so as to facilitate spectrum analysis. The frequency-domain transformation may include framing and a short-time Fourier transform (STFT).

It can be understood that, in practical applications, the input signal may be segmented into frames to obtain multiple analysis frames, and each analysis frame may be analyzed and processed on a frame-by-frame basis. In the embodiment, the reference-aligned signal x′, the microphone-aligned signal y′, and the filter output signal s′ may be respectively segmented into frames to obtain a reference-aligned signal frame \tilde{x}′(k), a microphone-aligned signal frame y\tilde{′}^{(k)}, and a filter-output signal frame \tilde{s}′(k). In this process, the last (N−Nₛ) samples of the previous analysis frame may be concatenated with the currently received input signal to form the current analysis frames:

$${\tilde{x}}^{′} ( k , n ) = \{ \begin{matrix}{\tilde{x}}^{′} ( k - 1 , n + {N}_{S} ) & n = 0 , 1 , … , ( N - {N}_{S} - 1 ) \\ {x}^{′} ( k , n - N + {N}_{S} ) & n = ( N - {N}_{S} ) , … , ( N - 1 )\end{matrix} ;$$

$${\tilde{y}}^{′} ( k , n ) = \{ \begin{matrix}{\tilde{y}}^{′} ( k - 1 , n + {N}_{S} ) & n = 0 , 1 , … , ( N - {N}_{S} - 1 ) \\ {y}^{′} ( k , n - N + {N}_{S} ) & n = ( N - {N}_{S} ) , … , ( N - 1 )\end{matrix} ;$$

$${\tilde{s}}^{′} ( k , n ) = \{ \begin{matrix}{\tilde{s}}^{′} ( k - 1 , n + {N}_{S} ) & n = 0 , 1 , … , ( N - {N}_{S} - 1 ) \\ {s}^{′} ( k , n - N + {N}_{S} ) & n = ( N - {N}_{S} ) , … , ( N - 1 )\end{matrix} ;$$

where n denotes the sample index, k denotes the frame index, L denotes the analysis frame length, and N_{S} denotes the number of newly input signals in each frame, and N=2^{┌log}^{₂}^{(N}^{_{S}}^{)┐}.

It should be noted that, in order to maintain the stationarity of the speech signal, the analysis frame length should not be excessively large. In one embodiment, the duration of the input signal for each frame may be set to 10 milliseconds. When the audio sampling rate is 16 kHz, the number of input samples per frame N_{S} is 160, and the analysis frame length N is 256.

It can be understood that the duration of each input signal and the audio sampling rate may be specified or adjusted according to actual requirements and application scenarios, and the present disclosure is not limited thereto.

Subsequently, the reference-aligned signal frame \tilde{x}′(k), the microphone-aligned signal frame \tilde{y}′(k), and the filter-output signal frame \tilde{s}′(k) may be subjected to a short-time Fourier transform, respectively, to obtain a reference-aligned transformed signal X′(k,u), a microphone-aligned transformed signal Y′(k,u), and a filter-output transformed signal S′(k,u), respectively, that is:

$${X}^{′} ( k , u ) = \frac{1}{N} \cdot {\sum }_{n = 0}^{N - 1} [ {\tilde{x}}^{′} ( k , n ) \cdot w ( n ) \cdot {e}^{- j \frac{2 π}{N} u n} ] ;$$

$${Y}^{′} ( k , u ) = \frac{1}{N} \cdot {\sum }_{n = 0}^{N - 1} [ {\tilde{y}}^{′} ( k , n ) \cdot w ( n ) \cdot {e}^{- j \frac{2 π}{N} u n} ] ;$$

$${S}^{′} ( k , u ) = \frac{1}{N} \cdot {\sum }_{n = 0}^{N - 1} [ {\tilde{s}}^{′} ( k , n ) \cdot w ( n ) {e}^{- j \frac{2 π}{N} u n} ] ;$$

where u denotes the frequency-bin index, w(n) denotes a window function of a preset length N, and j denotes the imaginary unit.

In one embodiment, a hybrid flat-top Hanning window may be used to apply windowing to the input signal. The first portion and the last portion of this window can together form a Hanning window containing exactly (N−N_{S}) points. The specific window function is defined as follows:

$$w ( n ) = \{ \begin{matrix}\sqrt{0.5 \times [ 1 - cos ( \frac{π \cdot n}{N - {N}_{s}} ) ]} & n = 0 , 1 , … , ( N - {N}_{s} - 1 ) \\ 1 & n = ( N - {N}_{s} ) , … , {N}_{s} \\ \sqrt{0.5 \times [ 1 - cos ( \frac{π \cdot ( N - n )}{N - {N}_{s}} ) ]} & n = ( {N}_{s} + 1 ) , … , ( N - 1 )\end{matrix} .$$

It can be understood that other types of window functions may be selected according to actual requirements, and the present disclosure is not limited thereto.

Step S2032: Determine a filter suppression component according to the reference-aligned transformed signal, the microphone-aligned transformed signal, and the filter-output transformed signal.

The filter suppression component refers to the signal suppressed by the adaptive filter. Specifically, the suppression component is [Y′(k,u)−S′(k,u)].

Step S2033: Extract an estimated speech component from the filter suppression component.

It should be understood that the adaptive filter is capable of suppressing the echo component, environmental noise, and a portion of the speech contained in the microphone input signal. Accordingly, the filter suppression component may include a noise component, an echo component, and a speech component. In one embodiment, an estimated speech component within the filter suppression component may be extracted based on an estimated noise component and an estimated echo component. Specifically, step S2033 may include the following process.

Step S2033a: Perform noise component estimation on the filter suppression component to obtain an estimated noise component.

In one embodiment, the environmental noise may be subjected to noise spectral density estimation to obtain an estimated noise spectral density.

It should be understood that the filter suppression component may be smoothed in the power spectrum domain to facilitate analysis and estimation of the noise component. Specifically, if the filter suppression component is [Y′(k,u)−S′(k,u)], its power spectral density is given by: P(k,u)=|Y′(k,u)|²−|S′(k,u)|². By performing frequency-domain smoothing on P(k,u), the following can be obtained:

$$\{ \begin{matrix}{P}^{′} ( k , u ) = P ( k , u ) & u = 0 , N - 1 \\ \begin{matrix}{P}^{′} ( k , u ) = α \cdot P ( k , u ) + ( \frac{1 - α}{2} ) \cdot \\ [ P ( k , u - 1 ) + P ( k , u + 1 ) ]\end{matrix} & u = 1 , … , N - 2\end{matrix} ,$$

where P′(k,u) denotes the frequency-smoothed power spectral density obtained by smoothing the power spectrum P(k,u) in the frequency domain, and a denotes the frequency smoothing coefficient, which may be specified or adjusted according to actual requirements and application scenarios, and the present disclosure is not limited thereto. Optionally, α may be set to 0.5.

Subsequently, a time-domain smoothing may be performed on P′(k,u) to obtain the time-smoothed power spectral density P″(k,u), i.e., P″(k,u)=β·P′(k,u)+(1−β)·P″(k−1,u), where β denotes a preset first time-domain smoothing coefficient, which may be specified or adjusted according to actual requirements and application scenarios, and the present disclosure is not limited thereto. Optionally, β may be set to 0.2.

It should be understood that, in a specific frequency band of a speech signal containing noise, most of the frame signals typically have relatively low energy and contain a larger proportion of noise components. Therefore, in one embodiment, the minimum time-smoothed power spectral density may be searched for noise spectral estimation. Specifically, after obtaining r consecutive estimates of the time-smoothed power spectral density P″(k,u), the minimum time-smoothed power spectral density Pₘᵢₙ″(k,u) may be updated as follows:

$${P}_{min}^{″} ( k , u ) = \{ \begin{matrix}min \{ {P}_{tmp}^{″} ( k - 1 , u ) , {P}^{″} ( k , u ) \} & mod ( k , r ) = 0 \\ min \{ {P}_{min}^{″} ( k - 1 , u ) , {P}^{″} ( k , u ) \} & mod ( k , r ) \neq 0\end{matrix} ;$$

$${P}_{tmp}^{″} ( k , u ) = \{ \begin{matrix}{P}^{″} ( k , u ) & mod ( k , r ) = 0 \\ min \{ {P}_{tmp}^{″} ( k - 1 , u ) , {P}^{″} ( k , u ) \} & mod ( k , r ) \neq 0\end{matrix} ;$$

where

$${P}_{tmp}^{″} ( k , u )$$

denotes the minimum spectral estimate between frames and can be regarded as a temporary buffer variable, with an initial value of P″(0,u); r denotes the number of frames for updating the inter-group state, such that the minimum power spectrum is re-estimated every r frames to improve accuracy. The value of r is related to the frame index k, which can be expressed as follows:

$$r ( k ) = \{ \begin{matrix}15 & 0 \leq k < 100 \\ 50 & 100 \leq k < 1000 \\ 150 & 1000 \leq k < 10000 \\ 300 & k \geq 10 \; 000\end{matrix} \begin{matrix} \\ \\ \\ \end{matrix} .$$

When the energy of a frequency bin in the estimated noise power spectral density P_{V}(k,u) is relatively low, the noise estimate P_{V}(k,u) for that frequency bin may be updated; otherwise, the previous estimate is maintained. That is, P_{V}(k,u) can be expressed as follows:

$${P}_{V} ( k , u ) = \{ \begin{matrix}max \{ 0 , [ ( 1 - γ ) \cdot \\ {P}_{V} ( k - 1 , u ) + γ \cdot P ( k , u ) ] \} \\ {P}_{V} ( k - 1 , u )\end{matrix} \begin{matrix}\{ \begin{matrix}{K}_{P} \times {P}^{″} ( k , u ) \leq {P}_{min}^{″} ( k , u ) \\ or P ( k , u ) < {P}_{V} ( k - 1 , u )\end{matrix} \\ Others\end{matrix} , \begin{matrix} \\ \end{matrix}$$

where γ denotes a smoothing factor and

$$γ = \{ 0.03 , \frac{1}{k + 1} \} ,$$

K_{P} denotes a decision threshold between the minimum time-smoothed power spectral density Pₘᵢₙ″(k,u) and the time-smoothed power spectral density P″(k,u), which may be specified or adjusted according to actual requirements and application scenarios, and the present disclosure is not limited thereto. Optionally, K_{P} may be set to 0.2. Accordingly, the estimated noise component can be obtained, i.e., \hat{V}′(k,u)=\sqrt{P_{V}(k,u)}.

Step S2033b: Perform echo component estimation on the filter suppression component to obtain an estimated echo component.

It should be understood that a detection may be performed based on the reference-aligned transformed signal and the microphone-aligned transformed signal to determine whether the current stage is an echo-only stage. If it is determined that the current stage is an echo-only stage, the filter suppression component may be used to estimate the echo component, thereby obtaining the estimated echo component. Specifically, when the correlation between the reference-aligned transformed signal and the microphone-aligned transformed signal is relatively high, while the correlation between the filter-output transformed signal and the microphone-aligned transformed signal is relatively low, it may be considered that the pickup device has not captured the user's speech, and the current stage may be regarded as the echo-only stage.

In one embodiment, a first correlation value |ρ_{XY}| between the reference-aligned transformed signal and the microphone-aligned transformed signal may be calculated, and a second correlation value |ρ_{SY}| between the filter-output transformed signal and the microphone-aligned transformed signal may also be calculated. The determination of whether the current stage is an echo-only stage may be made based on the first correlation value and the second correlation value. The method for calculating the correlation values may be set according to actual requirements, and the present disclosure is not limited thereto. Optionally, the first correlation value and the second correlation value may be calculated using the following equations:

$$\vert {ρ}_{X Y} \vert = \sqrt{{Corr}^{2} \{ {X}^{′} ( k ) , {Y}^{′} ( k ) \}} = \sqrt{\frac{{Cov}^{2} \{ {X}^{′} ( k ) , {Y}^{′} ( k ) \}}{Var \{ {X}^{′} ( k ) \} \cdot Var \{ {Y}^{′} ( k ) \}}} and$$

$$\vert {ρ}_{S Y} \vert = \sqrt{{Corr}^{2} \{ {S}^{′} ( k ) , {Y}^{′} ( k ) \}} = \sqrt{\frac{{Cov}^{2} \{ {S}^{′} ( k ) , {Y}^{′} ( k ) \}}{Var \{ {S}^{′} ( k ) \} \cdot Var \{ {Y}^{′} ( k ) \}}} ,$$

where Cov{⋅,⋅} denotes the covariance operation between two objects, Var{⋅} denotes the variance operation, and Corr{⋅,⋅} denotes the correlation coefficient between two objects. In the above calculations, squaring is performed prior to taking the square root to prevent the correlation value from being negative.

If the first correlation value |ρ_{XY}| is greater than a preset first threshold ρᵤₚ, and the second correlation value |ρ_{SY}| is less than a preset second threshold ρ_{down}, it may be considered that the current stage is the echo-only stage. The first threshold and the second threshold may be specified or adjusted according to actual requirements and application scenarios, and the present disclosure is not limited thereto.

During the echo-only stage, the filtered suppression component and the estimated noise component may be linearly fitted to obtain an estimated room impulse response and an estimated nonlinear component. Specifically, since the filter suppression component mainly contains the majority of the echo component and some noise components, Y′(k,u)−S′(k,u)=[X′(k,u)·H(k,u)+D′(k,u)]+\hat{V}′(k,u), where H(k,u) denotes the frequency-domain room impulse response, and D′(k,u) denotes the spectrum of the nonlinear echo component. Since U(k,u)=Y′(k,u)−S′(k,u)−\hat{V}′(k,u), then U(k,u)=X′(k,u)·H(k,u)+D′(k,u). Here, a least-squares method may be employed to perform linear fitting for each frequency bin u of the filtered suppression component and the estimated noise component, respectively. That is,

$$\hat{H} ( k , u ) = \frac{{\sum }_{k = 0}^{N - 1} [ {X}^{′} ( k , u ) - {\overline{X}}^{′} ( k , u ) ] [ {U}^{′} ( k , u ) - {\overline{U}}^{′} ( k , u ) ]}{{\sum }_{k = 0}^{N - 1} {[ {X}^{′} ( k , u ) - {\overline{X}}^{′} ( k , u ) ]}^{2}}$$

and \hat{D}′(k,u)=Ū′(k,u)−Ĥ(k,u)·X̅′(k,u), where X̅′(k,u) denotes the average of X′(k,u) over the accumulated frames of the filtered suppression component at frequency bin u; and Ū′(k,u) denotes the average of U′(k,u) over the accumulated frames of the estimated noise component at frequency bin u; Ĥ(k,u) denotes the estimated room impulse response, and \hat{D}′(k,u) denotes the estimated nonlinear component. Thereby, the fitting residual Ê(u) can be obtained as: Ê(u)=U′(k,u)−Ĥ(k,u)·X′(k,u)−\hat{D}′(k,u). The smaller the fitting residual, the better the fitting performance. Based on the estimated room impulse response Ĥ(k,u) and the estimated nonlinear component \hat{D}′(k,u), the estimated echo component can be obtained as: X′(k,u)·Ĥ(k,u)+\hat{D}′(k,u).

Step S2033c: Extract the estimated speech component from the filter suppression component according to the estimated noise component and the estimated echo component.

In one embodiment, the estimated speech component Ŝ′(k,u) within the filtered suppression component may be extracted, specifically as follows: Ŝ′(k,u)=max{0,[Y′(k,u)−S′(k,u)]−[X′(k,u)·Ĥ(k,u)+\hat{D}′(k,u)]−\hat{V}′(k,u)}, where max{⋅} denotes taking the maximum value. By the above expression, it is possible to prevent the estimated speech component \hat{X}′(k,u) from being negative.

Step S2034: Perform frequency-domain compensation on the filter output signal according to the estimated speech component to obtain a compensated speech frequency-domain signal.

In one embodiment, the filter output signal S′(k,u) corresponding to the estimated speech component Ŝ′(k,u) may be compensated in the frequency domain based on the estimated speech component. The specific formula is as follows:

$${\tilde{S}}^{′} ( k , u ) = {S}^{′} ( k , u ) \cdot [ 1 + \frac{\vert {\hat{S}}^{′} ( k , u ) \vert}{\vert {S}^{′} ( k , u ) \vert} ] ,$$

where S′(k,u) represents the compensated speech frequency-domain signal.

Subsequently, time-domain smoothing may be performed on \tilde{S}′(k,u) to obtain the time-smoothed compensated speech signal \tilde{\tilde{S}}′(k,u) in the frequency domain, that is: \tilde{\tilde{S}}′(k,u)=(1−λ)·\tilde{\tilde{S}}′(k−1,u)+λ·\tilde{S}′(k,u), where λ denotes a preset second time-domain smoothing coefficient, which may be specified or adjusted according to actual requirements and application scenarios, and the present disclosure is not limited thereto. Optionally, λ may be set to 0.3.

Step S2035: Perform time-domain transformation on the compensated speech frequency-domain signal to obtain the compensated speech signal.

In one embodiment, the time-smoothed compensated speech signal in the frequency domain may be transformed into the time domain to obtain the compensated speech signal. Specifically, an inverse Fourier transform may be performed on the compensated speech signal in the frequency domain to obtain the compensated speech signal frame \tilde{s}′(k,n) in the time domain, that is,

$${\tilde{s}}^{′} ( k , n ) = {\sum }_{u = 0}^{N - 1} \vert {\tilde{\tilde{S}}}^{′} ( k , u ) \vert \cdot {e}^{j \frac{2 π}{N} u n} n = 0 , 1 , … , N - 1.$$

To avoid spectral leakage, the compensated speech signal frame in the time domain may be windowed and then overlap-added with the previous compensated speech signal frame in the time domain, that is:

$${\hat{s}}^{′} ( k , n ) = \{ \begin{matrix}w ( n ) \cdot {\tilde{s}}^{′} ( k , n ) + {\hat{s}}^{′} ( k - 1 , n + {N}_{s} ) & n = 0 , 1 , … , ( N - {N}_{s} - 1 ) \\ w ( n ) \cdot {\tilde{s}}^{′} ( k , n ) & n = ( N - {N}_{s} ) , … , ( N - 1 )\end{matrix} ,$$

where w(n) denotes a preset window function, which may be a hybrid flat-top Hanning window. During the frame-overlap-add process, the first (N−N_{S}) samples of the current compensated speech signal frame in the time domain are added to the last (N−N_{S}) samples of the previous compensated speech signal frame. The first (N−N_{S}) samples of the current frame are output, while the last (N−N_{S}) samples are reserved for overlap with the next compensated speech signal frame. Accordingly, the output of the current compensated speech signal frame sₒᵤₜ′ in the time domain is:

$${s}_{o u t}^{′} ( k , n ) = {\hat{s}}^{′} ( k , n ) n = 0 , 1 , … , {N}_{s} - 1.$$

Accordingly, the compensated speech signal

$${s}_{o u t}^{′}$$

can be obtained.

Step S204: Perform nonlinear processing on the compensated speech signal to obtain an echo-cancelled speech signal.

In one embodiment, after obtaining the compensated speech signal, a preset nonlinear processing module may be applied to the compensated speech signal to eliminate any residual nonlinear echo, thereby obtaining the echo-cancelled speech signal s″.

It should be noted that, after obtaining the echo-cancelled speech signal, the signal may be subjected to speech recognition according to conventional processing procedures, and corresponding reply content may be generated based on the recognition results to continue the subsequent human-machine dialogue.

By implementing the method described above, speech compensation processing can be performed based on the reference-aligned signal and the microphone-aligned signal, resulting in a compensated speech signal. This can mitigate the undesired suppression of the speech signal during the echo cancellation process, reduce speech signal loss, and facilitate normal dialogue between the device 100 and the user.

It should be understood that sequence numbers of the foregoing processes do not mean an execution sequence in the above-mentioned embodiments. The execution sequence of the processes should be determined according to functions and internal logic of the processes, and should not be construed as any limitation on the implementation processes of the above-mentioned embodiments.

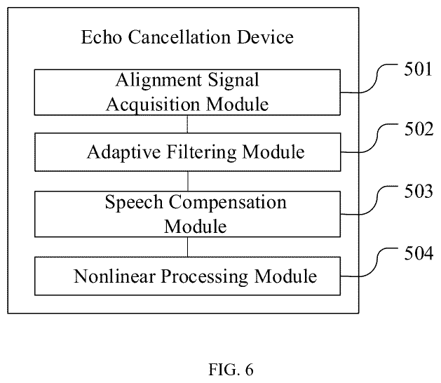

Corresponding to the echo cancellation method described in the above embodiments, FIG. 6 illustrates a schematic block diagram of an echo cancellation device according to one embodiment. The echo cancellation device may include an alignment signal acquisition module 501, an adaptive filtering module 502, a speech compensation module 503, and a nonlinear processing module 504. The alignment signal acquisition module 501 is to acquire a reference-aligned signal and a microphone-aligned signal. The adaptive filtering module 502 is to filter the reference-aligned signal and the microphone-aligned signal by using a preset adaptive filter to obtain a filter output signal. The speech compensation module 503 is to perform speech compensation processing on the filter output signal according to the reference-aligned signal and the microphone-aligned signal to obtain a compensated speech signal. The nonlinear processing module 504 is to perform nonlinear processing on the compensated speech signal to obtain an echo-cancelled speech signal.

In one embodiment, the speech compensation module 503 may include a frequency-domain transformation submodule, a suppression component determination submodule, an estimated speech component extraction submodule, a frequency-domain compensation submodule, and a time-domain transformation submodule. The frequency-domain transformation submodule is to perform frequency-domain transformation on the reference-aligned signal, the microphone-aligned signal, and the filter output signal to obtain a reference-aligned transformed signal, a microphone-aligned transformed signal, and a filter-output transformed signal. The suppression component determination submodule is to determine a filter suppression component according to the reference-aligned transformed signal, the microphone-aligned transformed signal, and the filter-output transformed signal. The estimated speech component extraction submodule is to extract an estimated speech component from the filter suppression component. The frequency-domain compensation submodule is to perform frequency-domain compensation on the filter output signal according to the estimated speech component to obtain a compensated speech frequency-domain signal. The time-domain transformation submodule is to perform time-domain transformation on the compensated speech frequency-domain signal to obtain the compensated speech signal.

In one embodiment, the estimated speech component extraction submodule may include a noise component estimation unit, an echo component estimation unit, and an estimated speech component extraction unit. The noise component estimation unit is to perform noise component estimation on the filter suppression component to obtain an estimated noise component. The echo component estimation unit is to perform echo component estimation on the filter suppression component to obtain an estimated echo component. The estimated speech component extraction unit is to extract the estimated speech component from the filter suppression component according to the estimated noise component and the estimated echo component.

In one embodiment, the estimated speech component extraction unit may include a first calculation subunit, a second calculation subunit, a linear fitting subunit, and an estimated echo component determination subunit. The first calculation sub-unit is to calculate a first correlation degree value between the reference-aligned transformed signal and the microphone-aligned transformed signal. The second calculation subunit is to calculate a second correlation degree value between the filter-output transformed signal and the microphone-aligned transformed signal. The linear fitting subunit is to, in response to the first correlation degree value being greater than a preset first threshold and the second correlation degree value being less than a preset second threshold, perform linear fitting on the filter suppression component and the estimated noise component to obtain an estimated room impulse response and an estimated nonlinear component. The estimated echo component determination subunit is to determine the estimated echo component according to the estimated room impulse response and the estimated nonlinear component.

In one embodiment, the frequency-domain transformation submodule may include a frame processing unit and a Fourier transform unit. The frame processing unit is to frame the reference-aligned signal, the microphone-aligned signal, and the filter output signal to obtain a reference-aligned signal frame, a microphone-aligned signal frame, and a filter-output signal frame. The Fourier transform unit is to perform short-time Fourier transform on the reference-aligned signal frame, the microphone-aligned signal frame, and the filter-output signal frame to obtain the reference-aligned transformed signal, the microphone-aligned transformed signal, and the filter-output transformed signal.

In one embodiment, the time-domain transformation submodule may include an inverse Fourier transform unit and frame-overlap-add processing unit. The inverse Fourier transform unit is to perform inverse Fourier transform on the compensated speech frequency-domain signal to obtain a compensated speech time-domain signal frame. The frame-overlap-add processing unit is to perform frame overlap-add processing on the compensated speech time-domain signal frame to obtain the compensated speech signal.

In one embodiment, the alignment signal acquisition module 501 may include an input signal acquisition submodule and a time-domain alignment submodule. The input signal acquisition submodule is to acquire a reference input signal and a microphone input signal. The time-domain alignment submodule is to perform time-domain alignment on the reference input signal and the microphone input signal to obtain the reference-aligned signal and the microphone-aligned signal.

Those skilled in the art will readily understand that, for the sake of convenience and conciseness in description, the specific working processes of the above-described device, modules, and units may refer to the corresponding processes in the foregoing method embodiments, and are not repeated herein.

In the above embodiments, the descriptions of each embodiment focus on different aspects. Any features not specifically described or disclosed in one embodiment may be referred to in the relevant descriptions of other embodiments.

Another aspect of the present disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In one embodiment, the computer-readable medium may be a disc or a flash drive having the computer instructions stored thereon.

It should be understood that the disclosed device and method can also be implemented in other manners. The device embodiments described above are merely illustrative. For example, the flowcharts and block diagrams in the accompanying drawings illustrate the architecture, functionality and operation of possible implementations of the device, method and computer program product according to embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition, functional modules in the embodiments of the present disclosure may be integrated into one independent part, or each of the modules may be independent, or two or more modules may be integrated into one independent part. in addition, functional modules in the embodiments of the present disclosure may be integrated into one independent part, or each of the modules may exist alone, or two or more modules may be integrated into one independent part. When the functions are implemented in the form of a software functional unit and sold or used as an independent product, the functions may be stored in a computer-readable storage medium. Based on such an understanding, the technical solutions in the present disclosure essentially, or the part contributing to the prior art, or some of the technical solutions may be implemented in a form of a software product. The computer software product is stored in a storage medium and includes several instructions for instructing a computer device (which may be a personal computer, a server, a network device, or the like) to perform all or some of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

A person skilled in the art can clearly understand that for the purpose of convenient and brief description, for specific working processes of the device, modules and units described above, reference may be made to corresponding processes in the embodiments of the foregoing method, which are not repeated herein.

In the embodiments above, the description of each embodiment has its own emphasis. For parts that are not detailed or described in one embodiment, reference may be made to related descriptions of other embodiments.

A person having ordinary skill in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

A person having ordinary skill in the art may clearly understand that the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device)/terminal device and method may be implemented in other manners. For example, the above-mentioned apparatus (device)/terminal device embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate parts may or may not be physically separate, and parts displayed as units may or may not be physical units, may be located in one position, or may be distributed on a plurality of network units. Some or all of the modules may be selected according to actual requirements to achieve the objectives of the solutions of the embodiments.

The functional units and modules in the embodiments may be integrated in one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random-access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented echo cancellation method comprising:
acquiring a reference-aligned signal and a microphone-aligned signal;
filtering the reference-aligned signal and the microphone-aligned signal by using a preset adaptive filter to obtain a filter output signal;
performing speech compensation processing on the filter output signal according to the reference-aligned signal and the microphone-aligned signal to obtain a compensated speech signal; and
performing nonlinear processing on the compensated speech signal to obtain an echo-cancelled speech signal.

2. The method of claim 1, wherein performing speech compensation processing on the filter output signal according to the reference-aligned signal and the microphone-aligned signal to obtain the compensated speech signal, comprises:
performing frequency-domain transformation on the reference-aligned signal, the microphone-aligned signal, and the filter output signal to obtain a reference-aligned transformed signal, a microphone-aligned transformed signal, and a filter-output transformed signal;
determining a filter suppression component according to the reference-aligned transformed signal, the microphone-aligned transformed signal, and the filter-output transformed signal;
extracting an estimated speech component from the filter suppression component;
performing frequency-domain compensation on the filter output signal according to the estimated speech component to obtain a compensated speech frequency-domain signal; and
performing time-domain transformation on the compensated speech frequency-domain signal to obtain the compensated speech signal.

3. The method of claim 2, wherein extracting an estimated speech component from the filter suppression component comprises:
performing noise component estimation on the filter suppression component to obtain an estimated noise component;
performing echo component estimation on the filter suppression component to obtain an estimated echo component; and
extracting the estimated speech component from the filter suppression component according to the estimated noise component and the estimated echo component.

4. The method of claim 3, wherein performing echo component estimation on the filter suppression component to obtain the estimated echo component comprises:
calculating a first correlation degree value between the reference-aligned transformed signal and the microphone-aligned transformed signal;
calculating a second correlation degree value between the filter-output transformed signal and the microphone-aligned transformed signal;
in response to the first correlation degree value being greater than a preset first threshold and the second correlation degree value being less than a preset second threshold, performing linear fitting on the filter suppression component and the estimated noise component to obtain an estimated room impulse response and an estimated nonlinear component; and
determining the estimated echo component according to the estimated room impulse response and the estimated nonlinear component.

5. The method of claim 2, wherein performing frequency-domain transformation on the reference-aligned signal, the microphone-aligned signal, and the filter output signal to obtain the reference-aligned transformed signal, the microphone-aligned transformed signal, and the filter-output transformed signal, comprises:
framing the reference-aligned signal, the microphone-aligned signal, and the filter output signal to obtain a reference-aligned signal frame, a microphone-aligned signal frame, and a filter-output signal frame; and
performing short-time Fourier transform on the reference-aligned signal frame, the microphone-aligned signal frame, and the filter-output signal frame to obtain the reference-aligned transformed signal, the microphone-aligned transformed signal, and the filter-output transformed signal.

6. The method of claim 5, wherein performing time-domain transformation on the compensated speech frequency-domain signal to obtain the compensated speech signal comprises:
performing inverse Fourier transform on the compensated speech frequency-domain signal to obtain a compensated speech time-domain signal frame; and
performing frame overlap-add processing on the compensated speech time-domain signal frame to obtain the compensated speech signal.

7. The method of claim 1, wherein acquiring the reference-aligned signal and the microphone-aligned signal comprises:
acquiring a reference input signal and a microphone input signal; and
performing time-domain alignment on the reference input signal and the microphone input signal to obtain the reference-aligned signal and the microphone-aligned signal.

8. A device comprising:
one or more processors; and
a memory coupled to the one or more processors, the memory storing programs that, when executed by the one or more processors, cause performance of operations comprising:
acquiring a reference-aligned signal and a microphone-aligned signal;
filtering the reference-aligned signal and the microphone-aligned signal by using a preset adaptive filter to obtain a filter output signal;
performing speech compensation processing on the filter output signal according to the reference-aligned signal and the microphone-aligned signal to obtain a compensated speech signal; and
performing nonlinear processing on the compensated speech signal to obtain an echo-cancelled speech signal.

9. The device of claim 8, wherein performing speech compensation processing on the filter output signal according to the reference-aligned signal and the microphone-aligned signal to obtain the compensated speech signal, comprises:
performing frequency-domain transformation on the reference-aligned signal, the microphone-aligned signal, and the filter output signal to obtain a reference-aligned transformed signal, a microphone-aligned transformed signal, and a filter-output transformed signal;
determining a filter suppression component according to the reference-aligned transformed signal, the microphone-aligned transformed signal, and the filter-output transformed signal;
extracting an estimated speech component from the filter suppression component;
performing frequency-domain compensation on the filter output signal according to the estimated speech component to obtain a compensated speech frequency-domain signal; and
performing time-domain transformation on the compensated speech frequency-domain signal to obtain the compensated speech signal.

10. The device of claim 9, wherein extracting an estimated speech component from the filter suppression component comprises:
performing noise component estimation on the filter suppression component to obtain an estimated noise component;
performing echo component estimation on the filter suppression component to obtain an estimated echo component; and
extracting the estimated speech component from the filter suppression component according to the estimated noise component and the estimated echo component.

11. The device of claim 10, wherein performing echo component estimation on the filter suppression component to obtain the estimated echo component comprises:
calculating a first correlation degree value between the reference-aligned transformed signal and the microphone-aligned transformed signal;
calculating a second correlation degree value between the filter-output transformed signal and the microphone-aligned transformed signal;
in response to the first correlation degree value being greater than a preset first threshold and the second correlation degree value being less than a preset second threshold, performing linear fitting on the filter suppression component and the estimated noise component to obtain an estimated room impulse response and an estimated nonlinear component; and
determining the estimated echo component according to the estimated room impulse response and the estimated nonlinear component.

12. The device of claim 9, wherein performing frequency-domain transformation on the reference-aligned signal, the microphone-aligned signal, and the filter output signal to obtain the reference-aligned transformed signal, the microphone-aligned transformed signal, and the filter-output transformed signal, comprises:
framing the reference-aligned signal, the microphone-aligned signal, and the filter output signal to obtain a reference-aligned signal frame, a microphone-aligned signal frame, and a filter-output signal frame; and
performing short-time Fourier transform on the reference-aligned signal frame, the microphone-aligned signal frame, and the filter-output signal frame to obtain the reference-aligned transformed signal, the microphone-aligned transformed signal, and the filter-output transformed signal.

13. The device of claim 12, wherein performing time-domain transformation on the compensated speech frequency-domain signal to obtain the compensated speech signal comprises:
performing inverse Fourier transform on the compensated speech frequency-domain signal to obtain a compensated speech time-domain signal frame; and
performing frame overlap-add processing on the compensated speech time-domain signal frame to obtain the compensated speech signal.

14. The device of claim 8, wherein acquiring the reference-aligned signal and the microphone-aligned signal comprises:
acquiring a reference input signal and a microphone input signal; and
performing time-domain alignment on the reference input signal and the microphone input signal to obtain the reference-aligned signal and the microphone-aligned signal.

15. A non-transitory computer-readable storage medium storing instructions that, when executed by at least one processor of an electronic device, cause the at least one processor to perform an echo cancellation method, the method comprising:
acquiring a reference-aligned signal and a microphone-aligned signal;
filtering the reference-aligned signal and the microphone-aligned signal by using a preset adaptive filter to obtain a filter output signal;
performing speech compensation processing on the filter output signal according to the reference-aligned signal and the microphone-aligned signal to obtain a compensated speech signal; and
performing nonlinear processing on the compensated speech signal to obtain an echo-cancelled speech signal.

16. The non-transitory computer-readable storage medium of claim 15, wherein performing speech compensation processing on the filter output signal according to the reference-aligned signal and the microphone-aligned signal to obtain the compensated speech signal, comprises:
performing frequency-domain transformation on the reference-aligned signal, the microphone-aligned signal, and the filter output signal to obtain a reference-aligned transformed signal, a microphone-aligned transformed signal, and a filter-output transformed signal;
determining a filter suppression component according to the reference-aligned transformed signal, the microphone-aligned transformed signal, and the filter-output transformed signal;
extracting an estimated speech component from the filter suppression component;
performing frequency-domain compensation on the filter output signal according to the estimated speech component to obtain a compensated speech frequency-domain signal; and
performing time-domain transformation on the compensated speech frequency-domain signal to obtain the compensated speech signal.

17. The non-transitory computer-readable storage medium of claim 16, wherein extracting an estimated speech component from the filter suppression component comprises:
performing noise component estimation on the filter suppression component to obtain an estimated noise component;
performing echo component estimation on the filter suppression component to obtain an estimated echo component; and
extracting the estimated speech component from the filter suppression component according to the estimated noise component and the estimated echo component.

18. The non-transitory computer-readable storage medium of claim 17, wherein performing echo component estimation on the filter suppression component to obtain the estimated echo component comprises:
calculating a first correlation degree value between the reference-aligned transformed signal and the microphone-aligned transformed signal;
calculating a second correlation degree value between the filter-output transformed signal and the microphone-aligned transformed signal;
in response to the first correlation degree value being greater than a preset first threshold and the second correlation degree value being less than a preset second threshold, performing linear fitting on the filter suppression component and the estimated noise component to obtain an estimated room impulse response and an estimated nonlinear component; and
determining the estimated echo component according to the estimated room impulse response and the estimated nonlinear component.

19. The non-transitory computer-readable storage medium of claim 16, wherein performing frequency-domain transformation on the reference-aligned signal, the microphone-aligned signal, and the filter output signal to obtain the reference-aligned transformed signal, the microphone-aligned transformed signal, and the filter-output transformed signal, comprises:
framing the reference-aligned signal, the microphone-aligned signal, and the filter output signal to obtain a reference-aligned signal frame, a microphone-aligned signal frame, and a filter-output signal frame; and
performing short-time Fourier transform on the reference-aligned signal frame, the microphone-aligned signal frame, and the filter-output signal frame to obtain the reference-aligned transformed signal, the microphone-aligned transformed signal, and the filter-output transformed signal.

20. The non-transitory computer-readable storage medium of claim 19, wherein performing time-domain transformation on the compensated speech frequency-domain signal to obtain the compensated speech signal comprises:
performing inverse Fourier transform on the compensated speech frequency-domain signal to obtain a compensated speech time-domain signal frame; and
performing frame overlap-add processing on the compensated speech time-domain signal frame to obtain the compensated speech signal.
